(19) United States
(12) Patent Application Publication
(10) Pub. No.: US 2014/0327347 A1
(43) Pub. Date: Nov. 6, 2014

(54) STERNBOARD DRIVE FOR MARINE ELECTRIC PROPULSION WITH SPEED CONTROL AND WIRELESS COMMUNICATION CONNECTIVITY

(71) Applicants: Andrew H. REBELE, Seattle, WA (US); Christopher M. GIL, Kent, WA (US); Kerwin M. LOUKUSA, Seattle, WA (US); Matthew M. O'BRIEN, Hermosa Beach, CA (US); Zachary Meyer OMOHUNDRO, Hermosa Beach, CA (US); Nathan SCHROEDER, Torrance, CA (US)

(72) Inventors: Andrew H. REBELE, Seattle, WA (US); Christopher M. GIL, Kent, WA (US); Kerwin M. LOUKUSA, Seattle, WA (US); Matthew M. O'BRIEN, Hermosa Beach, CA (US); Zachary Meyer OMOHUNDRO, Hermosa Beach, CA (US); Nathan SCHROEDER, Torrance, CA (US)

(73) Assignee: PURE WATERCRAFT, INC., Seattle, WA (US)

(21) Appl. No.: 14/271,404

(22) Filed: May 6, 2014

Related U.S. Application Data
(60) Provisional application No. 61/820,163, filed on May 6, 2013.

(51) Int. Cl. B63H 21/17; B63H 1/04; H02K 7/00; B63H 5/07

(52) U.S. Cl. CPC B63H 21/17; B63H 5/07; B63H 1/04; H02K 7/00
USPC 310/75 R

(57) ABSTRACT

The present invention deals with electric sternboard drives for marine electric propulsion with speed control and wireless communication connectivity.

### PRIORITY

The present invention claims the benefit of U.S. Provisional application 61/820,163 filed May 6, 2013.

### FIELD OF THE INVENTION

The present invention deals with electric sternboard drives for marine electric propulsion with speed control and wireless communication connectivity.

### BACKGROUND OF THE INVENTION

This invention pertains to a propulsion drive mounted to the transom of a marine vessel whereby the means of propulsion is an electric motor that forms a part of the drive. This invention constitutes an improvement to an existing sternboard drive, which is typically driven by a shaft that penetrates the transom and is powered by an internal combustion or diesel engine located inside the vessel.

### SUMMARY OF THE INVENTION

The present invention solves the aforementioned problem and provides a propulsion drive mounted to a transom of a marine vessel wherein the propulsion drive is driven by an electric motor that forms part of the propulsion drive.

### BRIEF DESCRIPTION OF THE DRAWINGS

FIG. 1 illustrates the sterndrive of the present invention.

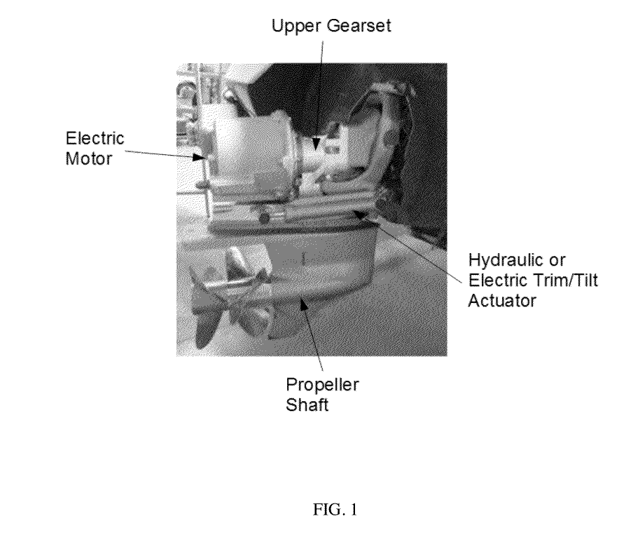

### DETAILED DESCRIPTION OF THE INVENTION

The drive consists of, at a minimum, an electric motor with stator/rotor and drive shaft, a propeller shaft, a means to transmit power from the electric motor drive shaft to the propeller shaft including required elements for the mechanical transmission, a housing within which some or all of the components are packaged, one or more propellers, a mounting interface to the transom of the vessel, and mechanisms by which the drive can be pivoted for steering, trim adjustment, and tilt adjustment. In some embodiments the drive can also include an electronic controller for control of the electric motor. In some embodiments the drive can also include one or more electric or hydraulic actuators for adjustment of trim and tilt. In some embodiments the drive can also include one or more electric or hydraulic actuators for adjustment of steering. In some embodiments the drive can also include a closed-loop liquid cooling system for the electric motor whereby coolant is pumped around or directly through the electric motor to remove excess heat and then through a heat exchanger to dissipate the excess heat. In some embodiments the closed-loop liquid cooling system is also used to lubricate the bearings and gears.

The electric motor can be oriented horizontally with its drive shaft pointing toward or away from the stern. In this configuration there would be a means to transmit power from the electric motor shaft to the parallel-oriented propeller shaft. This means could be a belt or chain connected to each shaft, or two right angle gear sets with intermediate shaft.

The electric motor can also be oriented vertically with its drive shaft pointing downward. In this configuration there would be one right angle gear set to transmit power from the electric motor shaft to the propeller shaft. There could also be a separate means to reduce or increase rotational speed relative to the electric motor shaft. This means could be an inline planetary gear set or a parallel shaft driven by gears, chain, or belt.

Sternboard drives (sometimes referred to as a “sterndrive”) are popular in recreational marine vessels, whereby an internal combustion or diesel engine resides inside the hull of the vessel and the drive is mounted to the transom of the vessel. These existing drives have many disadvantages. For example, a shaft must penetrate the transom to transmit power to the sternboard drive, which requires a sizable hole that weakens the transom and provides a potential leak path. The engine, which must be mounted adjacent to the transom, takes up a large amount of space in the hull that could be used for other purposes. The engine also adds a significant amount of weight in the rear of the vessel that requires ballast to be added elsewhere in the vessel for handling and stability. Engines also require frequent maintenance to keep them operating properly, and they produce harmful emissions, excessive noise, and undesirable odors.

The invention described herein holds many advantages over present technology. For example, since all of the mechanical power elements are located outside the hull there is no need for a large penetration through the transom. Aside from the structural attachment between the drive and transom, the only elements required to cross the transom plane are electrical harnesses which could be passed through a much smaller penetration or routed over the top edge of the transom. This significantly increases the structural capability and rigidity of the transom, and minimizes the potential for leakage into the hull.

Another advantage of the invention is that the electric motor, which replaces the engine, saves a significant amount of weight and is located outside the hull. This adds additional passenger or equipment volume inside the hull and eliminates the need for ballast. Some or all of the weight savings are negated by the weight of batteries, however the battery weight can be distributed throughout the hull as needed to optimize handling and stability.

Electric motors are inherently maintenance free, another advantage over existing marine engines. Additionally, electric propulsion generates zero emissions or odors and minimal acoustic noise compared with internal combustion or diesel engines.

### Speed Control

This invention is a new process enabled by the differing torque/power profile of an electric drive train. Internal combustion based drive trains do not allow for the fidelity of control at low engine speeds. This invention allows the user to select different speed profiles they currently wish to use. Speed profiles could offer enhanced low, mid or high-speed control, based on the user requirements.

Currently boats have throttle maps that are exponentially mapped, in that every increase in throttle position corresponds to a much larger torque request to the motor then the previous position. This allows for some increased fidelity at the low throttle positions, but decreased fidelity at the high ends. By allowing the user to choose between throttle mappings it allows the user to have a high fidelity of control at any speed.

One example would be a mid speed throttle map for use during towing a wake boarder. Wake boarders often desire a consistent boat speed, but because the throttle mappings at mid speed correspond to large changes in torque request with small changes in throttle position, it can be hard to adjust for wind speed, waves and other environmental factors and still keep a consistent speed. By having a middle speed throttle map it would allow for increased fidelity in this region and enhanced user experience.

User selectable speed profiles/throttle maps could be used in any application that has an electric drive train. Internal combustion based engines are not a good fit due to restrictions on torque curve, although with the introduction of high quality CVT transmissions selectable throttle maps may be viable in the future for internal combustion based drivetrains.

### Wireless Communication Capability for Marine Electric Propulsion System

This invention describes wireless communication capability for an marine electric propulsion system. The system includes a device with the capability to receive and transmit data by radio frequency with an external device with similar capability. The external device may reside in a mobile apparatus, such as a cellular phone, laptop computer, or tablet, or it may reside inside a non-mobile device such as a desktop computer. The marine electric propulsion system, in the current context, is meant to include the battery pack(s), propulsion device(s), electronic device(s) used to drive or control the propulsion device(s), charging device(s) used to charge the battery pack(s) (regardless of whether or not they are located aboard the marine vessel), and any other device(s) deemed necessary for proper operation of the marine electric propulsion system.

This capability enables many unique features of the electric propulsion system. Some of these features may include:
The ability to upgrade the software in the electric propulsion system without the need to physically connect a device to the system.
The ability to display and/or control real-time operating characteristics of the system. Typical display characteristics may include battery state of charge, output power, operational state, etc. Typical control capabilities may include setting the battery charge rate and setting timers that control when events such as charging begin and end.
The ability to collect statistics and other data from the propulsion system and its peripherals, and upload them to a server for analysis and diagnosis of the system from a remote location.
The ability to monitor, review, or analyze characteristics of the propulsion system and its peripherals for the purpose of providing advice on usage or recommendations for improvement, treatment or repair or the system.
The ability to remotely interface with the propulsion system and run diagnostic tests.
The ability to share data with others, such as usage statistics, marine routes, etc., by way of mediums such as email or social media.
The ability to share real-time location, direction of travel, speed, or other data related to the propulsion system with others.
The ability to remotely identify and locate the propulsion system in the event of theft, and report this information to the appropriate authorities.

Present marine technology does not permit the user to wirelessly interact with the propulsion system. In the event of a problem, the user must bring the product to an authorized repair technician, usually at a significant inconvenience to the user. The ability to remotely diagnose and possibly repair the product without the need to relocate it is a very novel feature.

The ability to perform software (firmware) upgrades without the need to bring the product in for service is also very novel. An example of this process could include the user receiving notification on their mobile device that a firmware upgrade is available. The user can then choose to download the firmware installation package to their mobile device, then wirelessly upgrade the firmware on the propulsion system.

Another novel feature is the ability to monitor statistics of the propulsion system over time to help improve the system performance or for early prediction of impending problems.

Uses for this invention for the marine industry include the ability to wirelessly communicate with electronic controllers, either at the system level of component level, to collect data and/or diagnose problems. The ability to perform these functions without physically interacting with the hardware is valuable in many different applications. The planned embodiment of this invention is an electric marine propulsion system, however the same hardware, software, and methods could be applied to other marine systems that use internal combustion or diesel engines that have electronic controls or instrumentation.

We Claim:

1. A propulsion drive mounted to a transom of a marine vessel wherein the propulsion drive is driven by an electric motor that forms part of the propulsion drive.
